(19) United States
(12) Patent Application Publication
(10) Pub. No.: US 2005/0102163 A1
(43) Pub. Date: May 12, 2005

(54) Method and system for delivering prescriptions to remote locations for patient retrieval

(76) Inventor: Michael E. Coughlin, Mission, KS (US)

Correspondence Address: Hovey Williams LLP, Suite 400, 2405 Grand Blvd., Kansas City, MO, 64108, US

(21) Appl. No.: 10/969,587

(22) Filed: Oct. 20, 2004

Related U.S. Application Data
(60) Provisional application No. 60/517,860, filed on Nov. 6, 2003.

(51) Int. Cl. G06F 17/60

(52) U.S. Cl. 705/2

(57) ABSTRACT

A method and system (10) for delivering a prescription filled at a central pharmacy to a remote location accessible by a patient is provided. The patient may retrieve the prescription located at the remote location at a time convenient for the patient. The system (10) broadly comprises: a filling mechanism (12) for filling the prescription; a delivery system (14) for transporting the filled prescription to the remote location; an automatic prescription delivery system (“APDS”) (16) for placing each prescription in a delivery container; a retrieval system (18) at the remote location for allowing the patient to retrieve the patient's filled prescription; and a first computer (20) in communication with the filling mechanism (12), the APDS (16), and the retrieval system (18) and including a memory (22) and a processor (24).

### RELATED APPLICATION

The present application is a non-provisional application and claims priority benefit of U.S. Provisional Application No. 60/517,860, filed Nov. 6, 2003, and entitled “METHOD AND SYSTEM FOR DELIVERING PRESCRIPTIONS TO REMOTE LOCATIONS FOR PATIENT PICK-UP,” which is hereby incorporated into the present application by reference.

### BACKGROUND OF THE INVENTION

1. Field of the Invention

The present invention relates to methods of delivering filled prescriptions to patients. More particularly, the invention relates to a method and system for delivering filled prescriptions to patients at remote locations accessible by the patients, wherein the patients may retrieve the filled prescriptions without interaction with persons located at the remote locations.

2. Description of the Related Art

Many prescriptions are manually filled and verified by pharmacists or their assistants in pharmacies. Such manual methods of filling and verifying prescriptions are time consuming, costly, and subject to errors. Automatic prescription systems alleviate many of these problems, and examples of such systems are disclosed in U.S. Pat. Nos. 5,337,919; 5,713,487; 5,762,235; 5,798,020, 5,860,563; 5,873,488; 5,897,024; 6,085,938; 6,161,721; 6,318,630; 6,155,485; 6,421,584; 6,206,590; 6,574,580; 6,343,711; 6,592,005; and 6,578,734, all of which are incorporated into the present application by reference.

Even the above-described automatic prescription systems still require that patients pick-up their prescriptions at the pharmacies where they are filled. Unfortunately, this is often inconvenient for the patients because many patients may not be able to pick-up their prescriptions during the operating hours of the pharmacies or may not be near a conventional pharmacy. Additionally, physical disabilities may limit the ability of particular patients to park, walk into the pharmacy, and wait in line to pick-up their prescriptions.

Accordingly, there is a need for an improved method and system of delivering prescriptions to patients that overcomes the limitations of the prior art. More particularly, there is a need for a method and system of delivering filled prescriptions to remote locations, so that patients may pick-up or otherwise retrieve filled prescriptions at locations and times more convenient for the patients.

### SUMMARY OF THE INVENTION

The present invention solves the above-described problems and provides a distinct advance in the art of delivering filled prescriptions to a patient. More particularly, the present invention provides a method and system for delivering filled prescriptions to a remote location designated by the patient so that the patient may pick-up or otherwise retrieve the filled prescriptions without interaction with a person located at the remote location. The present invention includes a master delivery system broadly comprising: a filling mechanism; a delivery system for transporting the filled prescriptions; an automatic prescription delivery system (“APDS”) for placing each prescription in a delivery container; a retrieval system at the remote location for allowing the patient to retrieve the patient's filled prescription; and a first computer in communication with the filling mechanism, the APDS, and the retrieval system and including a memory and processor.

The master delivery system is operable to receive and store in the memory a prescription order. The order is then filled by the filling mechanism, which preferably comprises an automatic medicament dispensing system (“AMDS”)that automatically fills the prescription order. After the prescription is filled, the prescription is prepared for delivery to the remote location using the delivery system. Based on the remote location, a particular type of delivery system is employed. Further dependent on the employed delivery system, the APDS places the prescription in a delivery container suitable for the employed delivery system. For example, if the remote location is immediately outside the pharmacy that filled the prescription, the delivery system that delivers the filled prescription may be a pneumatic tube system such as used at bank tellers' windows, and the delivery container may be a resealable tube. Alternatively, if the delivery system is a courier who delivers the filled prescription to the remote location, the delivery container may be a box or other carrying case that allows the courier to easily and safely transport the filled prescription to the remote location.

Once delivered to the retrieval system at the remote location, the prescription is ready for pick-up or retrieval by the patient. The patient may then retrieve the filled prescription at the patient's convenience. In some instances, the filled prescription may not be delivered to the remote location until the patient requests delivery, such as when the pneumatic tube system described above is used.

To retrieve the prescription from the retrieval system, the retrieval system requests the patient enter a unique identifier that authorizes the patient to retrieve the prescription. The patient is then provided with information about the particular medicament of the prescription and also given the option of speaking with a pharmacist via a teleconferencing system or other similar mechanism that at least provides audible communication capabilities with the pharmacist. The last step before retrieval of the prescription is payment, and the retrieval system provides for payment by credit or debit card or by feeding currency to the retrieval system.

By providing the method and system of delivering filled prescriptions as described herein, numerous advantages are realized. For example, the present invention allows the patient to retrieve the filled prescriptions at a location and time more convenient for the patient and without requiring travel to the pharmacy at which the prescriptions were filled. This is especially advantageous for patients who have physical difficulties that limit their movement. In addition to the time saved and ease in retrieving filled prescriptions, the present invention allows for a reduction in the number of employees at the pharmacy that fills the prescriptions. Because fewer patients are visiting the pharmacy, fewer employees are needed to retrieve the filled prescriptions, receive the patients' payments, and otherwise operate the customer-related aspects of the pharmacy. The present invention thus benefits the patient by providing a convenient method and system for retrieving filled prescriptions and further benefits the pharmacy by reducing operating costs.

These and other important aspects of the present invention are described more fully in the detailed description below.

### BRIEF DESCRIPTION OF THE DRAWING FIGURES

A preferred embodiment of the present invention is described in detail below with reference to the attached drawing figures, wherein:

FIG. 1 is a block diagram illustrating a plurality of components of a master delivery system of a preferred embodiment of the present invention;

FIG. 2 is a flowchart illustrating a plurality of steps that may be implemented to perform a method of the preferred embodiment of the present invention;

FIG. 3 is an isometric view of a retrieval system of the present invention, particularly illustrating a detail of a primary unit accessible by a patient for retrieving filled prescriptions; and

FIG. 4 is a block diagram illustrating a plurality of components for the retrieval system illustrated in FIG. 3.

The drawing figures do not limit the present invention to the specific embodiments disclosed and described herein. The drawings are not necessarily to scale, emphasis instead being placed upon clearly illustrating the principles of the invention.

### DETAILED DESCRIPTION OF THE PREFERRED EMBODIMENTS

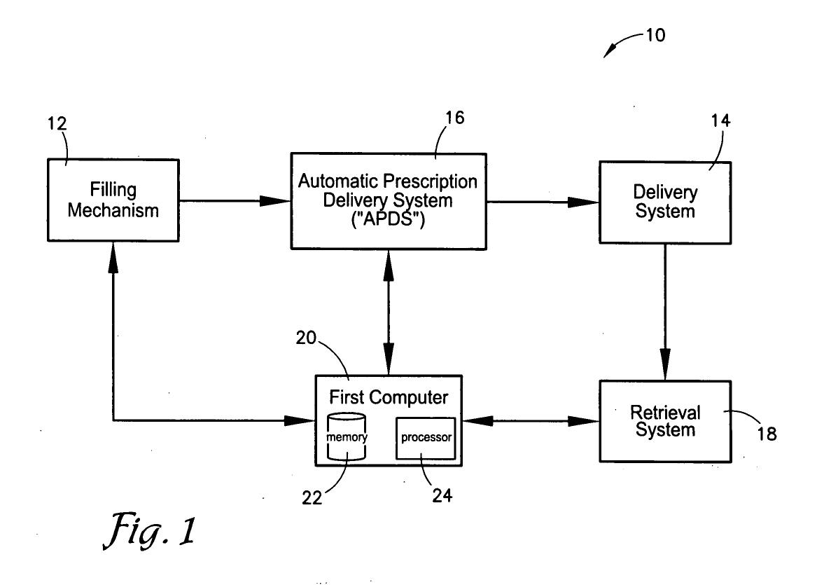

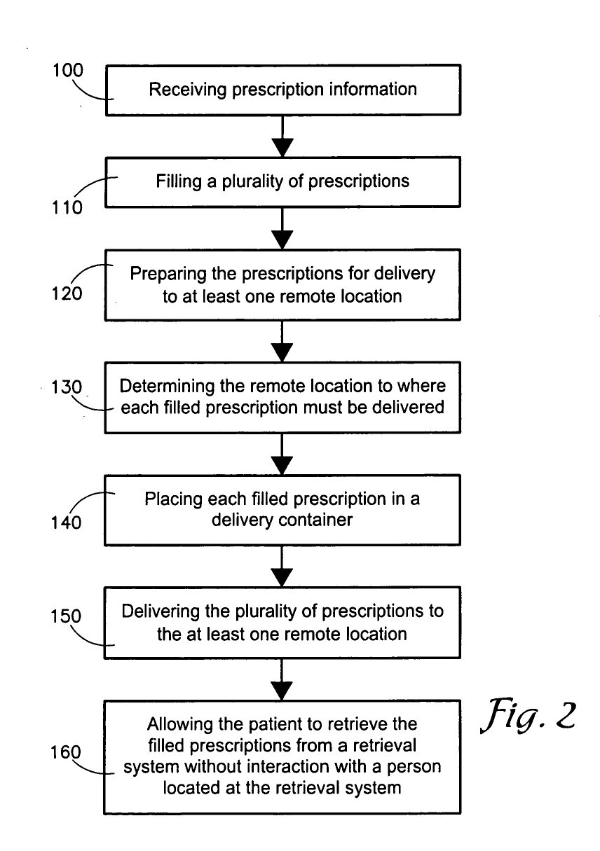

Turning now to the drawing figures, and particularly FIGS. 1-2, a method and system 10 for providing or delivering filled prescriptions to patients at a plurality of locations remote from a central pharmacy at which the prescriptions were filled are disclosed in accordance with a preferred embodiment of the present invention. As illustrated in FIG. 1, the present invention is preferably implemented with a master delivery system 10 broadly comprising: a filling mechanism 12 for filling the prescriptions; a delivery system 14 for transporting the filled prescriptions; an automatic prescription delivery system (“APDS”) 16 for placing each prescription in a delivery container; a retrieval system 18 at the remote location for allowing the patient to retrieve the patient's filled prescription; and a first computer 20 in communication with the filling mechanism 12, the APDS 16, and the retrieval system 18 and including a memory 22 and a processor 24. The present invention allows a patient to retrieve the filled prescriptions at a location and time convenient for the patient and without requiring travel to the central pharmacy at which the prescriptions were filled.

The central pharmacy of the present invention need not be a traditional pharmacy at which patients can visit in-person. Instead, the central pharmacy may only operate to fill prescriptions for delivery by the present invention. In this instance, the central pharmacy need not necessarily be at a locale convenient for patients to access. Further, the central pharmacy need not be as large as would otherwise be necessary if patients were actually visiting the pharmacy.

The remote locations contemplated by the present invention include locations both relatively near and far from the central pharmacy. For example, if the central pharmacy is located in a hospital or large suite of doctors' offices, the remote location may be immediately outside the hospital or offices at a location easily accessible by the patient via foot or vehicle. Alternatively, the remote location may be in a grocery store, bank, retail department store, or other location that is frequently visited within a particular community. Thus, the present invention contemplates multiple remote locations throughout a geographic region, such as a city, such that the central pharmacy serves all the remote locations within the region. The patient may then access the remote location closest and most accessible to the patient.

As indicated in step 100 of FIG. 2, the central pharmacy preferably first receives prescription information for the prescription by any known method, including calling, e-mailing, faxing, or simply hand-delivering the prescription information to the central pharmacy. Other methods of receiving the prescription information by the central pharmacy may be contemplated, and the above methods are not intended to be limiting. Receipt of the prescription information is preferred prior to filling of the prescription, as the prescription information comprises medicament information, including a type and number of medicaments; patient information, such as name, insurance carrier, sex, etc., for the patient associated with the prescription; the remote location to which the patient prefers the prescription be delivered; and identifying information, such as a social security number or assigned unique identifier, for the patient to be used when the patient retrieves the prescription from the retrieval system 18, as described in more detail below. Other information may be included in the prescription information, and the above list of information is not intended to be limiting. After receipt of the prescription information, the central pharmacy preferably stores the information in the memory 22 of the first computer 20, and such information may be accessed by the filling mechanism 12, the APDS 16, and the retrieval system 18, as described in more detail below.

After receiving the prescription information, the central pharmacy fills the prescription using the filling mechanism 12, as indicated in step 110 of FIG. 2. The filling mechanism 12 may comprise any known system and method, including hand-filling the prescription. Preferably, the filling mechanism 12 is an automatic medicament dispensing system (“AMDS”), as described in the above-referenced U.S. patents and as is known in the art. As such and as noted above, the first computer 20 is preferably in communication with the AMDS 12 and operable to transmit prescription information to the AMDS 12. The AMDS 12 is then operable to automatically fill the prescription.

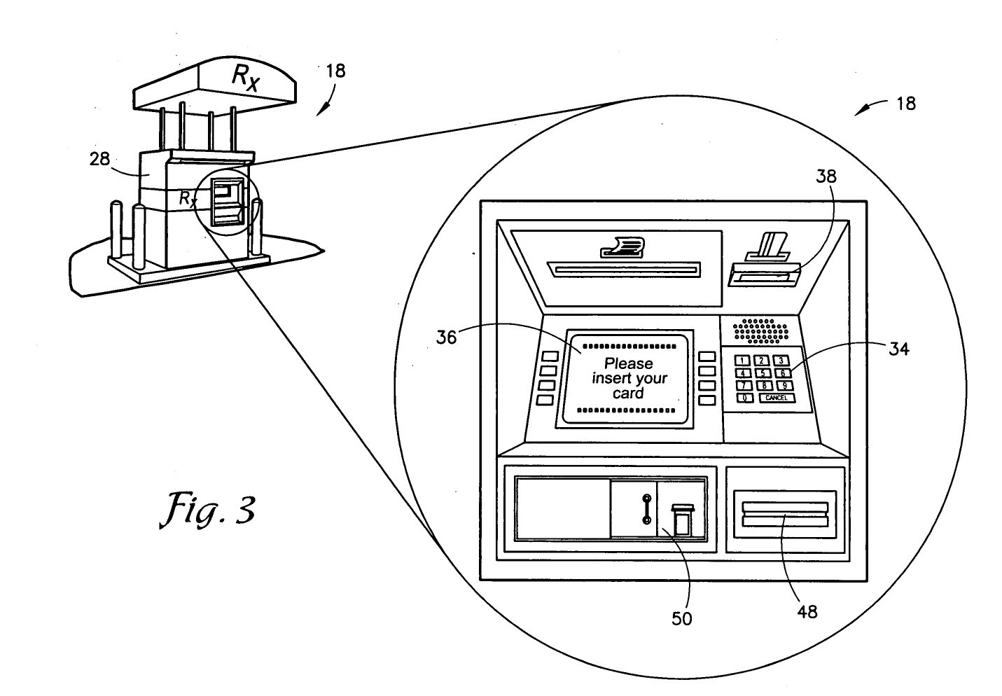

Once filled, the prescriptions are preferably prepared for delivery from the central pharmacy to one of the remote locations via the delivery system 14, as indicated in step 120. Because the remote locations may vary, as discussed above, the type of delivery system 14 used by the present invention is dependent on the type of remote location and the retrieval system 18 at the remote location, as indicated in step 130. The retrieval system 18, discussed in more detail below, includes a primary unit 28 for housing the components of the retrieval system 18. The primary unit 28 may be, for example, a drive-through or walk-up kiosk or window and may resemble an automated teller machine (“ATM”), as illustrated in FIG. 3, wherein the patient can drive or walk up to the primary unit 28 to retrieve the prescriptions.

The delivery system 14 for transporting the prescriptions from the central pharmacy to the primary unit 28 at the remote location will vary depending on the location of the unit 28 with respect to the central pharmacy, i.e., the distance from which the primary unit 28 and thus, the remote location, is positioned from the central pharmacy. For example, if the primary unit 28 is positioned immediately outside the central pharmacy, then the delivery system 14 may comprise a pneumatic tube system and resealable tube, similar to systems used at outdoor bank tellers' windows. Alternatively, if the primary unit 28 at the remote location is several miles or otherwise far away from the central pharmacy, then other methods of transporting the filled prescriptions to the primary unit must be used. One such method may employ a courier who picks-up the filled prescriptions from the central pharmacy and delivers the prescriptions to the primary unit 28 at the remote location, and the courier may do this for several different remote locations. Therefore, the delivery system 14 contemplated by the present invention may comprise many different systems and methods of operation, and the discussed systems and methods are not intended to be limiting.

Based on the delivery system 14 used for each remote location, the filled prescriptions are placed in the delivery containers particular for the remote locations preferably using the APDS 16, as indicated at step 140. As briefly discussed above, at or about the time the patient or the patient's doctor forwards the prescription order to the central pharmacy, the patient preferably identifies the remote location to which the patient prefers the prescriptions be delivered. This information may be saved on the memory 22 for retrieval by the APDS 16 when placing the filled prescriptions in the specific containers. The first computer 20 is then operable to communicate the remote location information to the APDS 16 for each prescription, and the APDS 16 is operable to automatically place each prescription in the delivery container specific for the remote location. For example, if the delivery system 14 for the remote location is the pneumatic tube system described above, then the delivery container may be the resealable tube. In contrast, if the delivery system 14 is the courier who picks up the prescriptions from the central pharmacy, then the delivery container may simply be a box or other carrying case that allows for safe transportation of the prescriptions by the courier.

In addition to placing each prescription into the particular delivery container specific for the delivery system 14 and remote location to which the prescription is being delivered, the APDS 16 is also preferably operable to separate the plurality of prescriptions based on the assigned remote locations for each prescription. This is especially advantageous if the filling mechanism 12 is operable to fill numerous prescriptions because the APDS 16 can then retrieve the filled prescriptions from the filling mechanism 12, determine where the prescriptions are to be delivered, and place each prescription in its respective delivery container.

Once the prescriptions are placed in the appropriate delivery containers, the filled prescriptions are delivered to the at least one remote location, as indicated in step 150. A time of delivery for each prescription is dependent on the delivery system 14 employed. For example, if the delivery system 14 is the pneumatic tube system described above and positioned immediately outside the central pharmacy, then delivery of the prescriptions may not take place until the patient is ready to retrieve the prescription from the retrieval system 18. Alternatively, if the delivery system 14 is the courier, then the courier may deliver several prescriptions for several different patients to each remote location all at once. Therefore, as noted above, the delivery system 14 used by the present invention is dependent on the remote location, and several types of delivery systems 12 are contemplated by the present invention.

The final step in providing the filled prescriptions to the patients is allowing the patients to retrieve the filled prescriptions from a retrieval system 18 located at the remote location without interaction with a person located at the retrieval system 18, as indicated in step 160. As discussed above, the retrieval system 18 preferably includes the primary unit 28 positioned at the remote location and easily accessible by the patient, as illustrated in FIG. 3. In preferred forms, the patient may either walk or drive up to the primary unit 28. Although the retrieval system 18 is preferably the ATM type of system comprising the primary unit 28 as discussed above, other retrieval systems 18 may be used. For example, the retrieval system 18 may be a counter at a grocery store or convenience store, where the patient simply walks-up, requests their prescription, and an assistant retrieves the prescription for the patient. In this implementation, the retrieval system 18 is still located at the remote location, which is a distance away from the central pharmacy that filled the prescription.

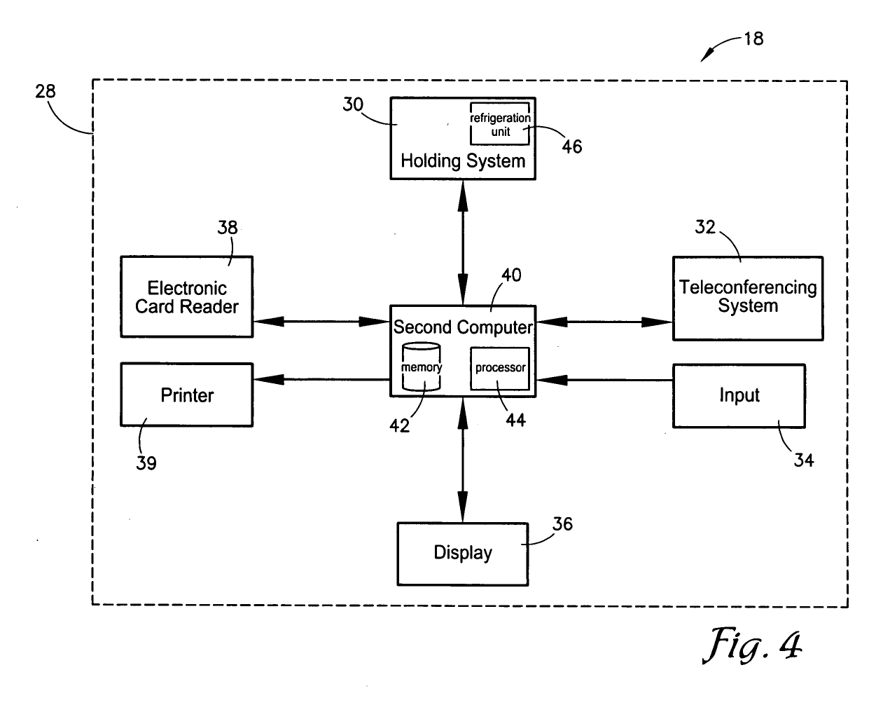

Preferably, the retrieval system 18 allows the patient to retrieve the prescription without interaction with a person located at the retrieval system 18. As illustrated in FIGS. 3 and 4, the retrieval system 18 thus preferably comprises a holding system 30 for the filled prescriptions, a teleconferencing system 32, an input 34, a display 36, an electronic card reader 38, a printer 39, and the primary unit 28 for housing the holding system 30, the teleconferencing system 32, the input 34, the display 36, the electronic card reader 38, and the printer 39. Further, the retrieval system 18 is preferably operable to receive and transmit information to the first computer 20 via an internal second computer 40 having a memory 42 and processor 44 and in communication with the first computer 20.

The holding system 30 is preferably internal to the primary unit 28 and is operable to hold each patient's filled prescription, should such be required, until the patient is ready to retrieve the prescription. For example, if the remote location is positioned far away from the central pharmacy such that the courier must deliver the prescriptions to the remote location, then several prescriptions for several different patients may be delivered to the remote location at any one time. The retrieval system 18, utilizing the holding system 30, is then preferably operable to hold the prescriptions until retrieval by the patient. This includes storing the prescriptions so that each prescription can be retrieved based on inputted patient identification information, as discussed in more detail below. The holding system 30 is then operable to transfer the patient's prescription that is housed in the primary unit 28 to the patient via a robotic arm (not shown), a conveyor system (not shown), or other suitable, well-known means. As such, the holding system 30 is preferably in communication with the second computer 40. The holding system 30 may also include a refrigeration unit 46 if the filled prescriptions include medicaments that require storage at a particular temperature.

If the remote location is immediately outside the central pharmacy, the holding system 30 may simply be a conduit in the primary unit 28 for transferring the prescription through the retrieval system 18 and to the patient. For example, if the pneumatic tube system is used, the filled prescription may be delivered from the central pharmacy and directly to the primary unit 28, which may then transfer the filled prescription immediately to the patient. Therefore, there may be no need to hold the prescription for an extended length of time in the primary unit 28 until retrieval by the patient.

Alternatively, the holding system 30 may be external to the primary unit 28, as may be the case if the primary unit 28 is positioned immediately outside the central pharmacy. As such, once the prescription is filled, it may be placed in the holding system 30, which is located in the central pharmacy. The holding system 30 may then place the filled prescription in the delivery container for delivery to the retrieval system 18 and transfer directly to the patient.

So as to properly identify the patient retrieving the prescription, the retrieval system 18 includes the input 34, display 36, and electronic card reader 38, each of which is housed in the primary unit 28. In preferred form, the patient inputs the patient's unique identifier, such as the patient's social security number or a password, using the input 34, which may be an alphanumeric keypad or other suitable input. Alternatively, the patient may swipe through the electronic card reader 38 a card having a magnetic strip on which is stored the unique identifier. The electronic card reader 38 is preferably in communication with the second computer 40 of the retrieval system 18.

The display 36 is preferably operable to display instructions to the patient on how to input the unique identifier and to further provide the patient with information on the filled prescription. For example, the display 36 is preferably operable to display a picture of the medicament comprising the filled prescription, along with relevant and important medical information related to the medicament. The display 36 may also be a touch-screen display and thus also function as the input 34. The patient may then print the information using the printer 39 housed within the primary unit 28.

Many jurisdictions have regulations and/or many insurance companies require that the patient sign or otherwise affirm that the patient had an opportunity to discuss the patient's prescription with a pharmacist. This may be especially needed if the patient is concerned about the medicament being taken, how the medicament interacts with other medicaments or foods the patient ingests, and other related concerns. Therefore, the present invention provides the teleconferencing system 32 to allow the patient to visually and audibly interact and otherwise communicate with a pharmacist not located at the remote location. Alternatively, the teleconferencing system 32 may simply allow audible communication between the patient and pharmacist via a telephone, for example.

The components of the teleconferencing system 32 are well-known in the art and will not be expanded upon here. However, the system 32 preferably provides the opportunity for the patient to view and hear the pharmacist and the pharmacist to view and hear the patient. The patient then has the opportunity to ask the pharmacist any questions the patient may have. The pharmacist may be located at the central pharmacy or any other suitable location where the pharmacist can answer the patient's questions via the teleconferencing system 32 or otherwise communicate with the patient.

In operation, once the delivery system 14 delivers the filled prescriptions to the at least one remote location, the filled prescriptions are available for retrieval by the patient. The patient may then visit the remote location at the patient's convenience. To use the retrieval system 18 at the remote location, the patient first preferably enters the patient's unique identifier, as described above. Information regarding the patient's filled prescriptions presently stored in the holding system 30 are displayed on the display 36. The patient then preferably selects the prescriptions the patient desires to retrieve. In conjunction with selecting each prescription, the retrieval system 18 preferably displays the picture of the medicament for the prescription and other related information, as described above. The patient may read this information from the display 36, print the information using the printer 39, or bypass receipt of the information altogether. Once the prescriptions to be retrieved are selected, the retrieval system 18 then asks the patient if the patient wishes to speak with a pharmacist via the teleconferencing system 32. If the patient requests such, the retrieval system 18 is operable to implement communication with the pharmacist via the teleconferencing system 32. If the patient does not request to speak with the pharmacist, the retrieval system 18 requests confirmation of such by the patient so as to provide documentation that the patient had an opportunity to speak with the pharmacist and declined.

The final step before delivery of the filled prescriptions to the patient is payment of the prescriptions. Preferably, the first computer 20 is provided with information regarding the patient's insurance prior to or in conjunction with filling the prescriptions. Therefore, the first computer 20 is operable to account for the patient's insurance and communicate to the second computer 40 the correct amount of payment for the prescriptions. To receive actual payment, the retrieval system 18 is preferably operable to receive a credit or debit card number by either swiping a credit or debit card through the electronic card reader 38 or inputting the number via the input 34, as is well known in the art. Alternatively, the retrieval system 18 may also be operable to receive currency supplied by the patient through a currency receipt slot 48 in the primary unit 28. Once the retrieval system 18 has confirmed payment by the patient, the patient's filled prescriptions are transferred from the holding system 30 and to the patient so that the patient may remove them from a dispensing location 50 in the primary unit 28.

The present invention thus provides an opportunity for the patient to pick-up or otherwise retrieve filled prescriptions at a location more accessible and at a time more convenient for the patient.

Although the invention has been described with reference to the preferred embodiment illustrated in the attached drawing figures, it is noted that equivalents may be employed and substitutions made herein without departing from the scope of the invention as recited in the claims. For example, the retrieval system 18 may be located within or immediately outside a second pharmacy that is not the central pharmacy that fills the prescription. The central pharmacy delivers the filled prescriptions to the second pharmacy that then transfers the filled prescriptions to the patient. In this alternative, by using the retrieval system 18 of the present invention, the patient also need not interact with a pharmacist at the second pharmacy. This alternative implementation may occur when, for example, prescriptions are filled in mass quantities at large, central pharmacies and then delivered to smaller, second pharmacies for transfer to the patients. Thus, delivery of the prescriptions may come from the second pharmacy that did not actually fill the prescription.

1. A method of providing a filled prescription to a patient at a location remote from a central pharmacy at which the prescription was filled, the method comprising the steps of:
preparing the filled prescription for delivery to the remote location;
delivering the prescription to the remote location via a delivery system; and
allowing the patient to retrieve the filled prescription from a retrieval system without interaction with a person located at the retrieval system.

2. The method as claimed in claim 1, wherein the remote location is located immediately outside the central pharmacy.

3. The method as claimed in claim 1, wherein the patient may retrieve the patient's prescriptions at any time of the day.

4. The method as claimed in claim 1, further including the step of receiving prescription information for the prescription, the prescription information including medicament information for the prescription and identifying information for the patient.

5. The method as claimed in claim 4, wherein the medicament information includes a type of medicament and the retrieval system is operable to provide a picture of the medicament to the patient when the patient retrieves the prescription.

6. The method as claimed in claim 1, further including the step of placing the filled prescription in a delivery container specific for the delivery system for the remote location, wherein placing the filled prescription in the delivery container is performed by an automatic prescription delivery system operable to receive information as to the remote location to which the prescription is to be delivered and to automatically place the prescription in the specific delivery container for the remote location.

7. The method as claimed in claim 6, wherein the delivery system is a courier who picks up the filled prescriptions from the central pharmacy and delivers the prescriptions to the retrieval system at the remote location.

8. The method as claimed in claim 6, wherein the delivery system is a pneumatic tube system operable to deliver the filled prescriptions from the central pharmacy and to the remote location.

9. The method as claimed in claim 1, wherein the retrieval system includes
a holding system for holding the filled prescriptions until transfer to the patient,
a teleconferencing system operable to provide audible and visual communication with a pharmacist not located at the remote location, and
a primary unit operable to house the holding system and teleconferencing system.

10. The method as claimed in claim 9, wherein the retrieval system is operable to receive payment from the patient for the prescriptions.

11. The method as claimed in claim 10, wherein the retrieval system is operable to request proof of identification of the patient prior to transferring the patient's prescriptions to the patient.

12. The method as claimed in claim 9, wherein the patient is operable to drive or walk up to the primary unit of the retrieval system.

13. A method of providing a plurality of filled prescriptions to a plurality of patients at a plurality of locations remote from a central pharmacy at which the prescriptions were filled, the method comprising the steps of:
determining a remote location to where each filled prescription must be delivered;
designating a delivery system for delivery of the filled prescriptions to at least one of the plurality of remote locations based on a distance separating the remote location from the central pharmacy;
separating the prescriptions based on the remote location to which each prescription is to be delivered;
placing each filled prescription in a delivery container specific for the designated delivery system for the determined remote location;
delivering the plurality of prescriptions to the at least one remote location using the designated delivery system; and
allowing the patient to retrieve the patient's filled prescriptions from a retrieval system located at the remote location without interaction with a person located at the retrieval system.

14. The method as claimed in claim 13, wherein the separating and placing of the filled prescriptions in the delivery containers is performed by an automatic prescription delivery system operable to receive information as to the remote location to which each prescription is to be delivered and to automatically place the prescription in the specific delivery container for the remote location.

15. The method as claimed in claim 14, further including the step of receiving prescription information for the prescription, the prescription information including medicament information for the prescription and identifying information for the patient.

16. The method as claimed in claim 15, wherein the delivery system is a courier who picks up the filled prescriptions from the central pharmacy and delivers the prescriptions to the retrieval system at the remote location.

17. The method as claimed in claim 15, wherein the delivery system is a pneumatic tube system operable to deliver the filled prescriptions from the central pharmacy and to the remote location.

18. The method as claimed in claim 15, wherein the retrieval system includes
a holding system for holding the filled prescriptions until transfer to the patient,
a teleconferencing system operable to provide audible and visual communication with a pharmacist not located at the remote location, and
a primary unit operable to house the holding system and teleconferencing system.

19. The method as claimed in claim 18, wherein the retrieval system is operable to receive payment from the patient for the prescriptions.

20. The method as claimed in claim 19, wherein the retrieval system is operable to request proof of identification of the patient prior to transferring the patient's prescriptions to the patient.

21. The method as claimed in claim 18, wherein the patient is operable to drive or walk up to the primary unit of the retrieval system.

22. A master delivery system for delivering a prescription filled at a central pharmacy to a remote location, the system comprising:
a delivery system for transporting the filled prescription from the central pharmacy to the remote location;
an automatic prescription delivery system (“APDS”) operable to place the filled prescription in a delivery container used by the delivery system for transport to the remote location;
a retrieval system located at the remote location and operable to allow the patient to retrieve the patient's filled prescription without interaction with a person located at the retrieval system; and
a computer in communication with the APDS and the retrieval system and including
a memory for storing identification information for the filled prescription, including a patient associated with the prescription, the remote location for the patient, and identifying information for the patient, and
a processor operable to access the identification information for the filled prescription and communicate such to the APDS so as to allow the APDS to place the filled prescription in the delivery container specific for the remote location identified for the patient, and to the retrieval system so as to allow the patient to retrieve the prescription from the retrieval system by inputting the patient's identifying information.

23. The master delivery system as claimed in claim 22, wherein the delivery system is a courier who picks up the filled prescriptions from the central pharmacy and delivers the prescriptions to the retrieval system at the remote location.

24. The master delivery system as claimed in claim 22, wherein the delivery system is a pneumatic tube system operable to deliver the filled prescriptions from the central pharmacy and to the remote location.

25. The master delivery system as claimed in claim 22, wherein the retrieval system includes
a holding system for holding the filled prescriptions until transfer to the patient,
a teleconferencing system operable to provide audible and visual communication with a pharmacist not located at the remote location, and
a primary unit operable to house the holding system and teleconferencing system.

26. The master delivery system as claimed in claim 25, wherein the retrieval system is operable to receive payment from the patient for the prescriptions.

27. The master delivery system as claimed in claim 26, wherein the retrieval system is operable to request proof of identification of the patient prior to transferring the patient's prescriptions to the patient.

28. The master delivery system as claimed in claim 27, wherein the patient is operable to drive or walk up to the primary unit of the retrieval system.

29. The master delivery system as claimed in claim 25, wherein the medicament information includes a type of medicament and the retrieval system is operable to provide a picture of the medicament to the patient when the patient retrieves the prescription.
